(19) United States
(12) Patent Application Publication
(10) Pub. No.: US 2005/0198437 A1
(43) Pub. Date: Sep. 8, 2005

(54) Method and system for coalescing coherence messages

(76) Inventor: Shubhendu S. Mukherjee, Framingham, MA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/796,520

(22) Filed: Mar. 8, 2004

(51) Int. Cl. G06F 12/16

(52) U.S. Cl. 711/118

(57) ABSTRACT

The ability to combine a plurality of remote read miss requests and/or a plurality of exclusive access requests into a single network packet for efficiently utilizing network bandwidth. This combination exists for a plurality of processors in a network configuration. In contrast, other solutions have inefficiently utilized network bandwidth by individually transmitting a plurality of remote read miss requests and/or a plurality of exclusive access requests via a plurality of network packets.

### BACKGROUND

1. Field

This disclosure generally relates to shared memory systems, specifically, relating to coalescing coherence messages

2. Background Information

The demand for more powerful computers and communication products has resulted in faster networks with multiple processors in a shared memory configuration. For example, the networks support a large number of processors and memory modules communicating with one another using a cache coherence protocol. In such systems, a processor's cache miss to a remote memory module (or another processor's cache) and consequent miss response are encapsulated in network packets and delivered to the appropriate processors or memories. The performance of many parallel applications, such as database servers, depends on how rapidly and how many of these miss requests and responses can be processed by the system. Consequently, a need exists for networks to deliver packets with low latency and high bandwidth.

### BRIEF DESCRIPTION OF THE DRAWINGS

Subject matter is particularly pointed out and distinctly claimed in the concluding portion of the specification. The claimed subject matter, however, both as to organization and method of operation, together with objects, features, and advantages thereof, may best be understood by reference to the following detailed description when read with the accompanying drawings in which:

FIG. 1 is a method of a flowchart for combining remote read miss requests in accordance with the claimed subject matter.

FIG. 2 is a method of a flowchart for combining write miss requests in accordance with the claimed subject matter.

FIG. 3 is a system diagram illustrating a system that may employ the embodiment of either FIG. 1 or FIG. 2 or both of them.

FIG. 4 is a system diagram illustrating a system that may employ the embodiment of either FIG. 1 or FIG. 2 or both of them.

### DETAILED DESCRIPTION

In the following detailed description, numerous specific details are set forth in order to provide a thorough understanding of the claimed subject matter. However, it will be understood by those skilled in the art that the claimed subject matter may be practiced without these specific details. In other instances, well-known methods, procedures, components and circuits have not been described in detail so as not to obscure the claimed subject matter.

An area of current technological development relates to networks delivering packets with low latency and high bandwidth. Presently, the prior art network packets carrying coherence protocol messages are usually small because either they carry simple coherence information (e.g., acknowledgement or request message) or small cache blocks (e.g., 64 bytes). Consequently, coherence protocols typically use network bandwidth inefficiently. Furthermore, more exotic higher performance coherence protocols can further degrade bandwidth utilization.

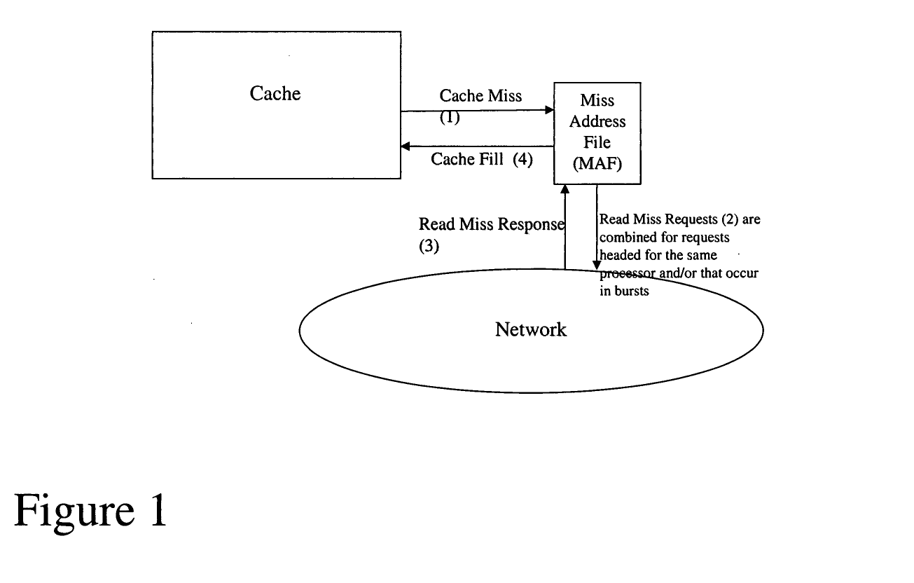

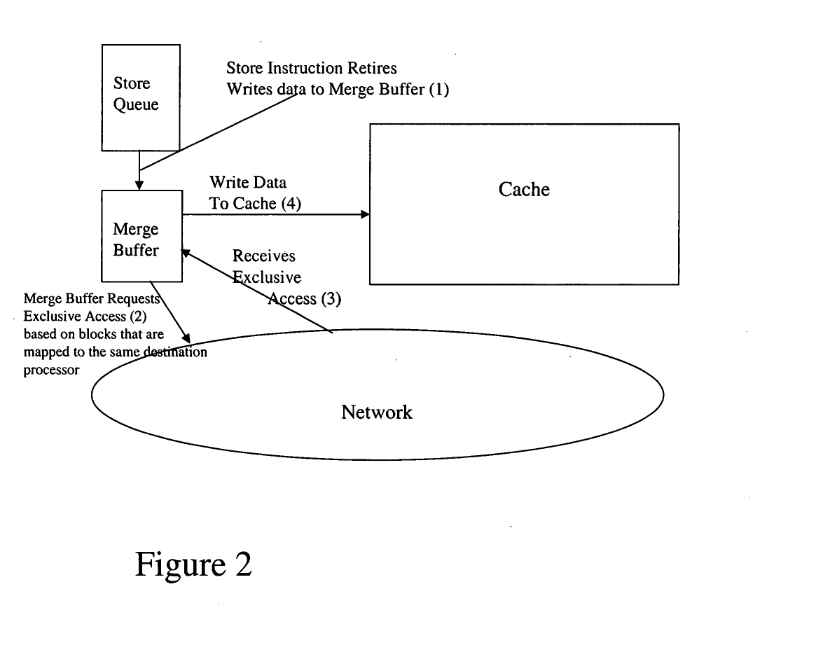

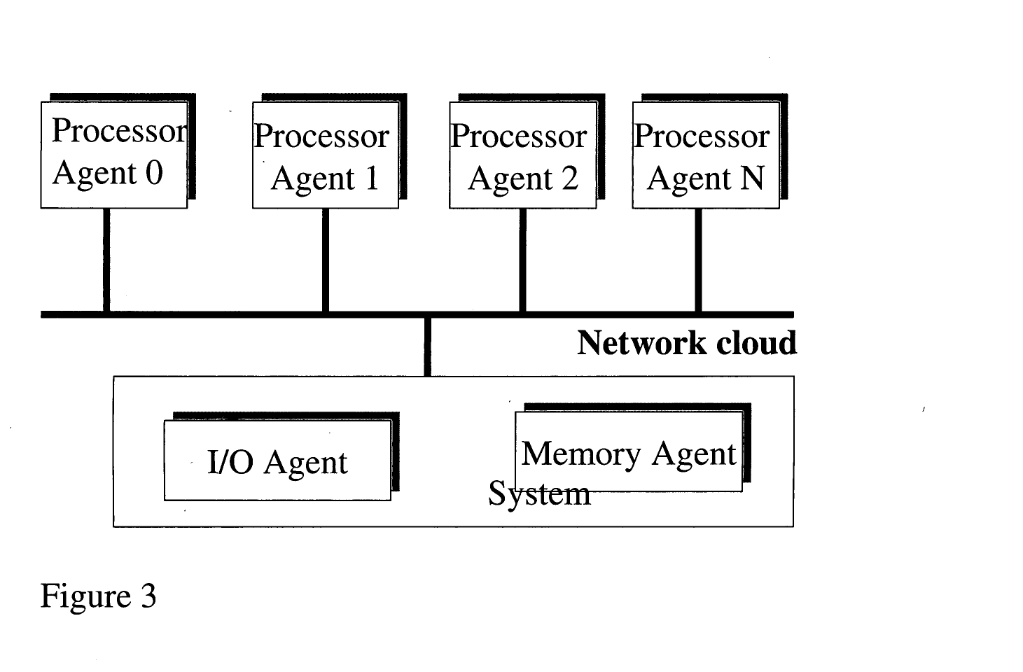

In contrast, the claimed subject matter facilitates combining multiple logical coherence messages into a single network packet to amortize the overhead of moving a network packet. In one aspect, the claimed subject matter may effectively use the available network bandwidth. In one embodiment, the claimed subject matter combines multiple remote read miss requests into a single network packet. In a second embodiment, the claimed subject matter combines multiple remote write miss requests into a single network packet. The claimed subject matter supports both of the previous embodiments as illustrated by FIGS. 1 and 2, respectively. Also, the claimed subject matter facilitates a system utilizing either or both of the previous embodiments as illustrated in the system in connection with FIG. 3.

FIG. 1 is a method of a flowchart for combining remote read miss requests in accordance with the claimed subject matter. A typical remote read miss operation begins with a processor encountering a read miss. Consequently, the system posts a miss request in a Miss Address File (MAF). Typically, a MAF will hold a plurality of miss requests. Subsequently, the MAF controller individually transmits the miss requests into the network. Eventually, the system network responds to each request with a network packet. Upon receiving the response, the MAF controller returns the cache block associated with the initial miss request to the cache and deallocates the corresponding MAF entry.

The claimed subject matter proposes combining logic read miss requests into a single network packet at the MAF controller. In one embodiment, the read miss requests are combined for miss requests destined to the same processor and that occur in bursts. The bursts may occur from either a program stream through an array in a scientific application or through leaf nodes of B+ trees in a database program. However, the claimed subject matter is not limited to the preceding examples of bursts. One skilled in the art appreciates a wide variety of programs or applications that result in read miss requests being generated in burst due to video and gaming applications, other scientific applications, etc.

In one embodiment, upon noticing a miss request, the MAF controller may wait a predetermined number of cycles before forwarding the cache miss request into the network. Meanwhile, during this delay, other miss requests destined for the same processor may arrive. Consequently, the batch of read miss requests headed for the same processor may be combined into one network packet and forwarded into the network.

FIG. 2 is a method of a flowchart for combining write miss requests in accordance with the claimed subject matter. Typically, a microprocessor utilizes a store queue for buffering in-flight store operations. After a store is completed (retired), consequently, there is a write of the data to a coalescing merge buffer, wherein this buffer has multiple cache block-sized chunks. For the store operation that writes data into the merge buffer, one needs to find a matching block for writing the data into it. Otherwise, it allocates a new block. In the event the merge buffer is full, one needs to deallocate (free up) a block from the buffer. When the processor needs to write a block back to the cache from the merge buffer, the processor must first request “exclusive” access to write this cache block to the local cache. If the local cache already has exclusive access, then the processor is done. If not, then this exclusive access must be granted by the home node, which often resides in a remote processor.

The claimed subject matter utilizes that writes to cache blocks may occur in bursts and/or are to sequential addresses. For example, the writes may often be mapped to the same destination processor in a directory-based protocol. Therefore, when one needs to deallocate a block from the merge buffer, a search of the merge buffer is initiated for identifying blocks that are mapped to the same destination processor. Upon identifying a plurality of blocks that are mapped to the same destination processor, the claimed subject matter facilitates combining the exclusive access requests into a single network packet and transmits it into the network. Therefore, one single network packet is transmitted for the plurality of exclusive access requests. In contrast, the prior art teaches transmitting network packets for each access request.

In one embodiment, a remote directory controller may end up in a deadlock situation while processing coalesced write miss requests from multiple processors. For example, if it receives requests for block A, B, & C from processor 1 and B, C, & D from processor 2 and starts servicing both requests, then the following situation may occur. It will acquire write permission for the block A for processor 1 and write permission for block B for processor 2. Consequently, there is a deadlock because the remote directory controller can not get block B because it is already locked out for the second coalesced request. For the preceding deadlock situation, in one embodiment, the solution is to preventing the processing of any coalesced write request at the directory controller, if any block that the request needs is already in a prior outstanding coalesced write request.

FIG. 3 is a system diagram illustrating a system that may employ the embodiment of either FIG. 1 or FIG. 2 or both. The multiprocessor system is intended to represent a range of systems having multiple processors, for example, computer systems, real-time monitoring systems, etc. Alternative multiprocessor systems can include more, fewer and/or different components. In certain situations, the described herein can be applied to both single processor and to multiprocessor systems. In one embodiment, the system is a shared cache coherent shared memory configuration with multiprocessors. For example, the system may support 16 processors. As previously described, the system supports either or both of the embodiments depicted in connection with FIGS. 1 and 2. In one embodiment, processor agents are coupled to the I/O and memory agent and other processor agents via a network cloud. For example, the network cloud may be a bus.

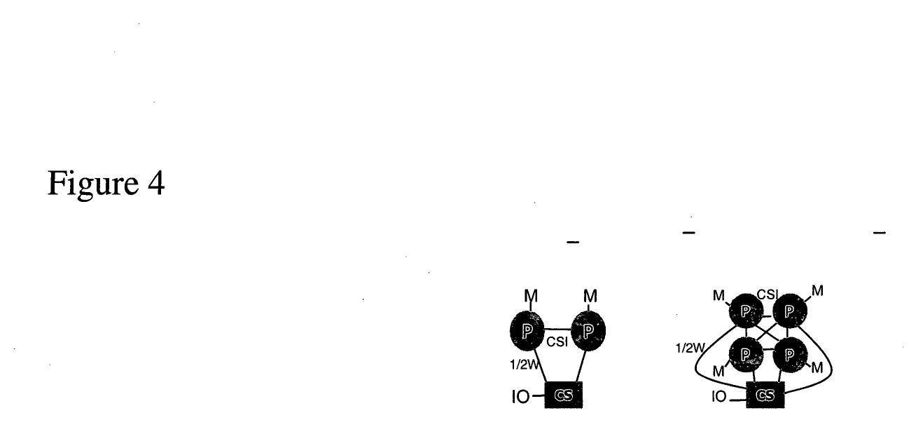

In an alternative embodiment, FIG. 4 depicts a point to point system. The claimed subject matter comprises two embodiments, one with two processors (P) and one with four processors (P). In both embodiments, each processor is coupled to a memory (M) and is connected to each processor via a network fabric may comprise either or all of: a link layer, a protocol layer, a routing layer, a transport layer. The fabric facilitates transporting messages from one protocol (home or caching agent) to another protocol for a point to point network. As previously described, the system of a network fabric supports either or both of the embodiments depicted in connection with FIGS. 1 and 2.

Although the claimed subject matter has been described with reference to specific embodiments, this description is not meant to be construed in a limiting sense. Various modifications of the disclosed embodiment, as well as alternative embodiments of the claimed subject matter, will become apparent to persons skilled in the art upon reference to the description of the claimed subject matter. It is contemplated, therefore, that such modifications can be made without departing from the spirit or scope of the claimed subject matter as defined in the appended claims.

1. A method for combining a plurality of read miss requests into a single network packet for a network of a plurality of processors comprising:
generating an entry in a Miss Address File (MAF) for each of the plurality of read miss requests;
delaying the MAF controller from forwarding the plurality of read miss requests for a predetermined number of cycles; and
combining the plurality of read miss requests that are destined to the same processor into a single network packet; and
forwarding the single network packet to that same processor.

2. The method of claim 1 wherein the plurality of read miss requests that are destined to the same processor occur in a burst from either a program stream through an array in a scientific application or through leaf nodes of B+ trees in a database program.

3. The method of claim 1 wherein the network is a cache-coherent shared memory configuration.

4. A method for combining a plurality of read miss requests into a single network packet for a network of a plurality of processors comprising:
generating an entry in a Miss Address File (MAF) for each of the plurality of read miss requests;
delaying the MAF controller from forwarding the plurality of read miss requests for a predetermined number of cycles; and
combining the plurality of read miss requests that are destined to the same processor and that occur in bursts into a single network packet; and
forwarding the single network packet to that same processor.

5. The method of claim 4 wherein the plurality of read miss requests that occur in bursts come from either a program stream through an array in a scientific application or through leaf nodes of B+ trees in a database program.

6. The method of claim 4 wherein the network is a cache-coherent shared memory configuration.

7. A method for combining a plurality of exclusive access requests into a single network packet for a network of a plurality of processors comprising:
identifying a plurality of exclusive access requests by at least one of the plurality of processors for writing a cache block to a local cache; and
combining the plurality of exclusive access requests into a single network packet to be transmitted in the network.

8. The method of claim 7 wherein the plurality of exclusive access requests is granted by a home node in the network.

9. A system comprising:
a plurality of processors, coupled to a network and memory, with each processor having a merge buffer to:
write data into an entry in the merge buffer upon retiring a store operation and
deallocate an entry in the merge buffer, and to identify a plurality of entries in the merge buffer that are mapped to the same processor among the plurality of processors and
to combine the plurality of entries in the merge buffer that are mapped to the same processor among the plurality of processors into a single network packet.

10. The system of claim 9 wherein the network is a point to point link among a plurality of cache agents and home agents.

11. The system of claim 9 wherein the system is a cache-coherent shared-memory multiprocessor system.
